(19) United States
(12) Patent Application Publication
(10) Pub. No.: US 2019/0119818 A1
(43) Pub. Date: Apr. 25, 2019

(54) HEAT SHIELD HAVING AN OUTERMOST YTTRIUM OXIDE COATING, PRODUCTION METHOD AND PRODUCT

(71) Applicant: Siemens Aktiengesellschaft, München (DE)

(72) Inventors: Georg Bostanjoglo, Berlin (DE); Arturo Flores Renteria, Berlin (DE); Helge Reymann, Berlin (DE); Dimitrios Zois, Berlin (DE)

(21) Appl. No.: 16/094,238

(22) PCT Filed: Apr. 20, 2017
(86) PCT No.: PCT/EP2017/059318

§ 371 Date: Oct. 17, 2018

(30) Foreign Application Priority Data
Apr. 25, 2016 (DE) 10 2016 206 968.3

(51) Int. Cl. C23C 28/04; C23C 4/11; C04B 41/00; C04B 41/50; C04B 41/87; C04B 41/52; C04B 41/89; F23R 3/00; F23M 5/00; F01D 5/28

(52) U.S. Cl. CPC C23C 28/04; C23C 4/11; C04B 41/009; C04B 41/5045; C04B 41/87; C23C 4/134; C04B 41/89; F23R 3/007; F23M 5/00; F01D 5/288; C04B 41/52

(57) ABSTRACT

The corrosion and erosion resistance of ceramic heat shield elements is improved by the use of yttrium oxide on aluminum oxide as a layer or substrate material is provided. A heat is disclosed having aluminum oxide in the substrate or as a layer on a substrate, wherein yttrium oxide, particularly only yttrium oxide, is present as the outermost layer, particularly directly on the aluminum oxide.

### CROSS-REFERENCE TO RELATED APPLICATIONS

This application claims priority to PCT Application No. PCT/EP2017/059318, having a filing date of Apr. 20, 2017, based on German Application No. 10 2016 206 968.3, having a filing date of Apr. 25, 2016, the entire contents both of which are hereby incorporated by reference.

### FIELD OF TECHNOLOGY

The following relates to heat shields which comprise a solid ceramic or which comprise coated metallic substrates and an outermost yttrium oxide layer, to a production method and to a product.

### BACKGROUND

Ceramic heat shields may be produced from solid ceramic and in this case preferably comprise mullite as the solid material. In addition, a further coating, such as aluminum oxide, may be present on the ceramic substrate.

Similarly, there are heat shield elements with a metallic substrate in the case of which an aluminum oxide layer, a TBC, which serves for heat insulation, is present on a metallic adhesion promoter layer.

However, depending on porosity or abrasion, there may be erosion at the first stage of the downstream turbine of the combustion system, which is undesired.

### SUMMARY

An aspect relates to a ceramic heat shield, a method and a product.

The ceramic heat shield elements of solid ceramic comprise or consist preferably of mullite (2Al₂O3xSiO₂) and/or aluminum oxide.

The mullite phases preferably comprise grains of up to 1 mm and are distributed in a fine-grained matrix. The mullite phase is not stable under hot gas conditions and breaks down above temperatures of 1673K under the influence of water vapor to form aluminum oxide and Si(OH)_{4.} For protection, the solid ceramic heat shields (CHS) therefore have an erosion barrier coating (EBC), which consists of a thin layer of 100 μm to 400 μm of aluminum oxide. The aluminum oxide layer is preferably applied by a plasma spraying process or other spraying processes.

The corrosion and abrasion resistance is improved by the use of yttrium oxide as the outermost barrier coating on the aluminum oxide.

The reason for this is that yttrium oxide forms yttrium aluminum garnet (YAG) as a result of the strong bonding of aluminum oxide in the CHS or EBC layer. A heat treatment above 1573K for preferably one hour causes a sufficiently thick yttrium garnet layer (YAG layer) to form.

### BRIEF DESCRIPTION

Some of the embodiments will be described in detail, with references to the following Figures, wherein like designations denote like members, wherein:

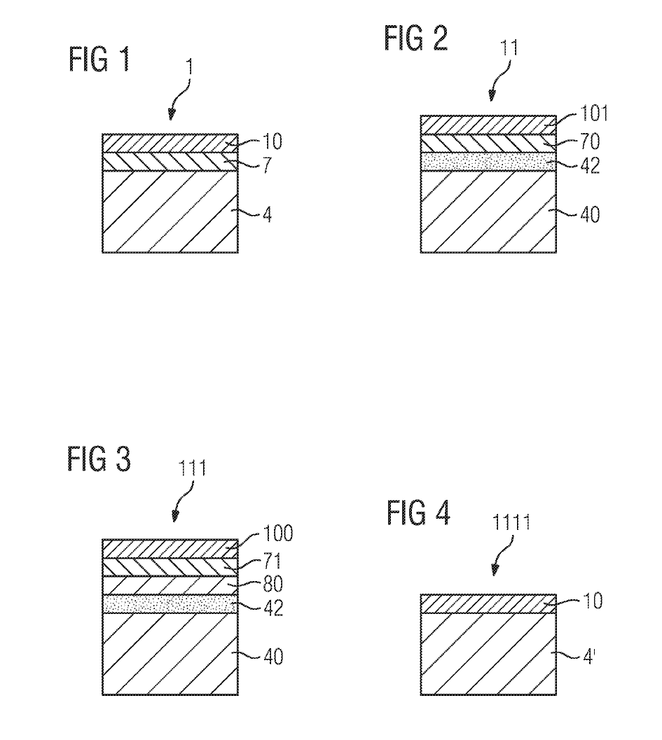

FIG. 1 shows a solid ceramic heat shield element;

FIG. 2 shows a metallic heat shield with a metallic substrate;

FIG. 3 shows a further exemplary embodiment of the invention on the basis of FIG. 2; and

FIG. 4 shows a layer that has solid ceramic and comprises mullite and/or aluminum oxide.

### DETAILED DESCRIPTION

The figures and the description only represent exemplary embodiments of the invention.

In FIG. 1, a solid ceramic heat shield 1 is represented.

The substrate 4 consists of solid ceramic as described above and comprises mullite and/or aluminum oxide or preferably even only aluminum oxide (Al₂O₃) (FIG. 4: 4′, 1111). An aluminum oxide layer 7 is applied as described above on the mullite or on the aluminum oxide/mullite of the substrate 4, 4′.

According to embodiments of the invention, an yttrium oxide layer 10 is applied as the outermost layer. With a pure aluminum oxide substrate (4′), there is no need for the aluminum oxide layer 7 (FIG. 4).

FIG. 2 shows a metallic heat shield 11 with a metallic substrate 40, on which a metallic adhesion promoter layer 42 is present, particularly an NiCoCrAlY alloy with an aluminum oxide layer 70, which has formed or is present as a result of deliberate oxidation of a metallic adhesion promoter layer 42 and/or by application of an aluminum oxide layer. An yttrium oxide layer 101 is likewise present as the outermost layer.

FIG. 3 shows a further exemplary embodiment 111 of the invention on the basis of FIG. 2, in which a ceramic thermal barrier coating (TBC) 80 is also present on the metallic adhesion promoter layer 42 with an aluminum oxide layer 71, as is known from ceramic protection systems of turbine blades. In addition, an outermost yttrium oxide layer 100 is likewise present.

A ceramically forming aluminum oxide layer (TGO) is also present between the metallic adhesion promoter layer 42 and the TBC 80.

The yttrium oxide layer 10, 100, 101 or the yttrium oxide preferably only comprises yttrium oxide, particularly consists thereof.

This means that there is no yttrium oxide as a stabilizer of ZrO₂ such as a Y₂O₃—ZrO₂.

The yttrium oxide or the yttrium oxide layer 10, 100, 101 is preferably applied directly on the aluminum oxide or on the aluminum oxide layer 7, 70, 71.

The aforementioned heat treatment causes an yttrium garnet layer to form (FIG. 1 to FIG. 4).

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A heat shield,
comprising
aluminum oxide in the substrate or as a layer on a substrate,
wherein yttrium oxide,
is present as the outermost layer.

2. The solid ceramic heat shield as claimed in claim 1,
in which the material of the substrate comprises mullite, with an intermediate aluminum oxide layer and an outermost yttrium oxide layer.

3. The solid ceramic heat shield as claimed in claim 1,
in which the material of the substrate comprises mullite and aluminum oxide,
particularly consists thereof.

4. The solid ceramic heat shield as claimed in claim 1,
in which the material of the substrate consists only of aluminum oxide.

5. The heat shield as claimed in claim 1,
which at least comprises
a metallic substrate,
a metallic adhesion promoter layer,
with an aluminum oxide layer formed by oxidation and/or a separately applied aluminum oxide layer, on which an outermost yttrium oxide layer is applied.

6. The heat shield as claimed in claim 5,
in which a ceramic thermal barrier coating,
is present between a metallic adhesion promoter layer and an aluminum oxide layer.

7. The heat shield as claimed in claim 1,
in which the yttrium oxide layer only comprises yttrium oxide,
in particular consists thereof,
and/or only yttrium oxide is used.

8. A method for producing a heat shield,
in which, starting from a heat shield as claimed in claim 1, a heat treatment is carried out at least 1573K,
for at least one hour.

9. A heat shield,
produced as claimed in claim 8.
